(19) United States
(12) Patent Application Publication
(10) Pub. No.: US 2010/0226612 A1
(43) Pub. Date: Sep. 9, 2010

(54) Optical receptacle and plug with simple structure

(75) Inventors: Stephen Sedio, Valley Center, CA (US); James M. Sabo, Harrisburg, PA (US); Robert Hall, Sherwood, OR (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/381,013

(22) Filed: Mar. 6, 2009

(51) Int. Cl. G02B 6/38; G02B 6/36

(52) U.S. Cl. 385/93; 385/75

(57) ABSTRACT

An optical receptacle (100) includes an insulative housing (1), a pair of power contacts (2) and an optical fiber component (3) retained in the insulative housing (1). The insulative housing (1) have a body portion (11), a tongue portion (12) extending forwardly from the body portion (11), a pair of passageways (123) extending through insulative housing (1), and a receiving cavity (114) below the passageways (123). The body portion (11) has a pair of opposed front face (110) and rear face (111), and a pair of opposed upper face (112) and lower face (113). Each power contacts (2) has a contacting portion (21), a soldering portion (23) and a retaining portion (22) connecting with the contacting portion (21) and the soldering portion (23. The optical fiber component (3) is retained in the receiving cavity (114) and being exposed to exterior through the front face (110).

### BACKGROUND OF THE INVENTION

1. Field of the Invention

The present invention relates to a receptacle and a plug for an optical connector assembly, more particularly to an optical connector assembly with simple structure.

2. Description of the Related Art

In information technology, Universal Serial Bus (USB) is a serial bus standard to interface devices. USB can connect computer peripherals such as computer mouse, keyboards, PDAs, gamepads and joysticks, scanners, digital cameras, printers, personal media players, and flash drives. For many of those devices, USB has become the standard connection method and is used widely.

The design of USB is standardized by the USB Implementers Forum (USB-IF), an industry standards body incorporating leading companies from the computer and electronics industries. As of 2006, the USB specification was at version 2.0. While the current USB 2.0 version has a top data-transfer rate of 480 megabits per second which does not efficiently meet requirement of data transmission speed for optical drives such as DVD, Blue-ray and HD DVD. As of 2008, the USB 3.0 specification was released and was standardized by the USB-IF at the end of 2008. The USB 3.0 specification is available from website: http://www.usb.org/home. The USB 3.0 version adds two pairs of differential signal contacts and a power contact than USB 2.0 version for increasing transmission speed thereof.

However, the USB 3.0 version has a complex structure by adding the two pairs of the differential signal contacts to USB 2.0 version, USB 3.0 connector would be produced difficultly.

### BRIEF SUMMARY OF THE INVENTION

According to one aspect of the present invention, an optical receptacle comprises: an insulative housing having a body portion, a tongue portion extending forwardly from the body portion, a pair of passageways extending through the tongue portion and the body portion, and a receiving cavity below the passageways, the body portion defining a front face, a rear face opposite to the front face, an upper face and a lower face opposite to the upper face; a pair of power contacts received in the passageways respectively, each power contacts defining a contacting portion extending to the tongue portion, a soldering portion and a retaining portion connecting with the contacting portion and the soldering portion; an optical fiber component retained in the receiving cavity and being exposed to exterior through the front face.

According to another aspect of the present invention, an optical plug for connecting an optical receptacle comprises: an insulative housing having a body portion, a tongue plate extending forwardly from the body portion, the tongue plate defining a pair of passageways and a receiving space extending therethrough; a pair of power terminals retained in the passageways, each power terminal having a contacting portion extending to the tongue plate; and an optical fiber component retained in the receiving space.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a perspective view of an optical receptacle and an optical plug according to the present invention;

FIG. 2 is a perspective view of an optical receptacle shown in FIG. 1;

FIG. 3 is a front view of the optical receptacle shown in FIG. 1;

FIG. 4 is a perspective view of the optical receptacle shown in FIG. 1 with a metal shell removed;

FIG. 5 is a view similar to FIG. 4, while taken from a different aspect;

FIG. 6 is an exploded view of the optical receptacle shown in FIG. 4;

FIG. 7 is a view similar to FIG. 6, while taken from a different aspect;

FIG. 8 is a front view of an optical plug according to the present invention;

FIG. 9 is a partly exploded perspective view of the optical plug shown in FIG. 8; and

FIG. 10 is a view similar to FIG. 9, while taken from a different aspect.

### DETAILED DESCRIPTION OF THE PREFERRED EMBODIMENTS

Reference will be made to the drawing figures to describe the present invention in detail, wherein depicted elements are not necessarily shown to scale and wherein like or similar elements are designated by same or similar reference numeral through the several views and same or similar terminology.

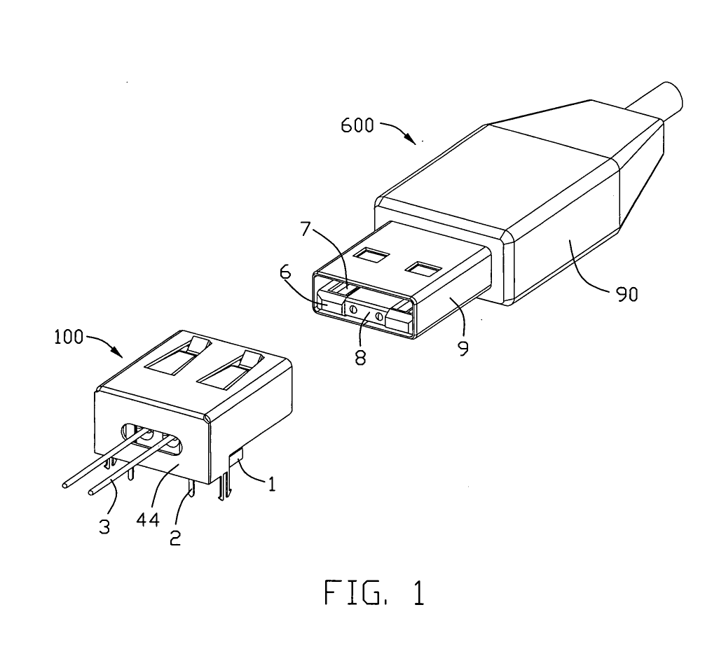

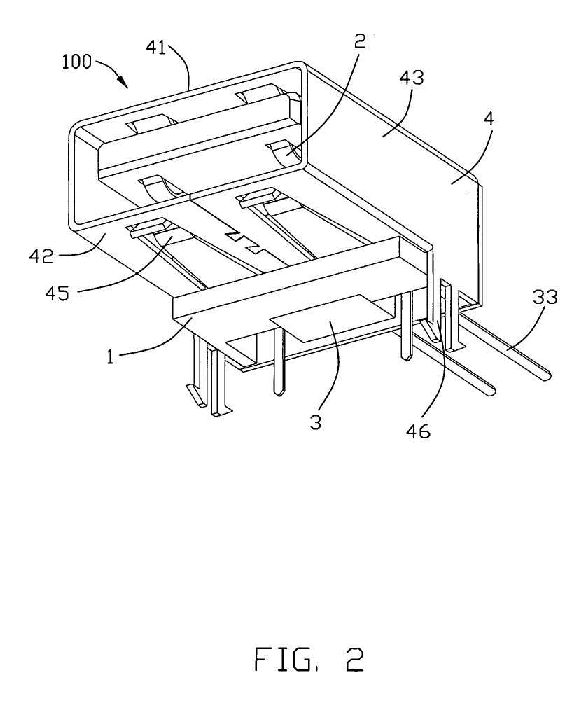

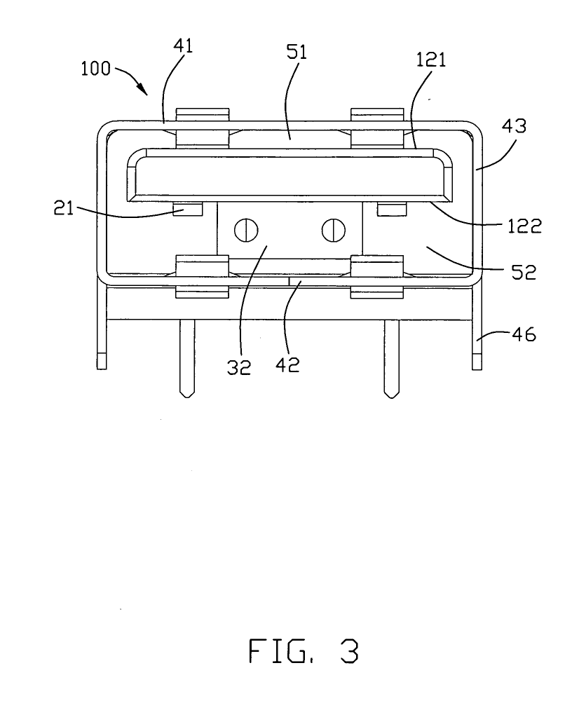

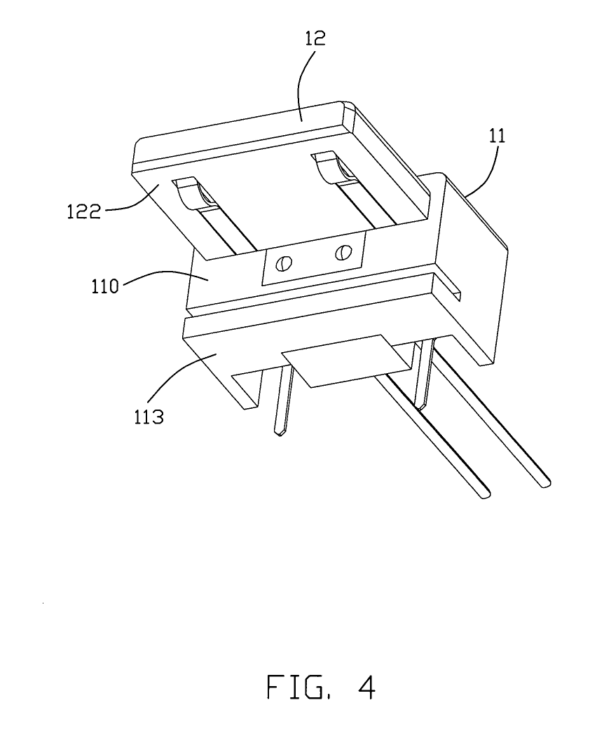

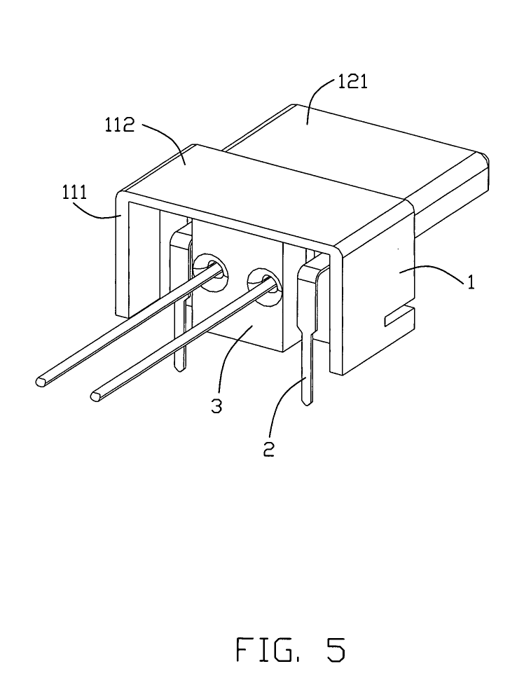

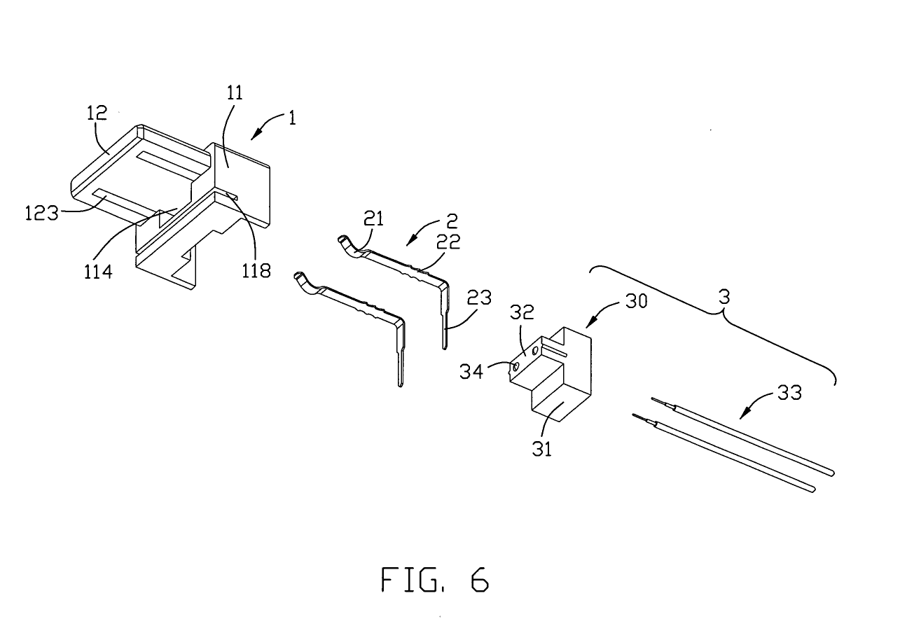

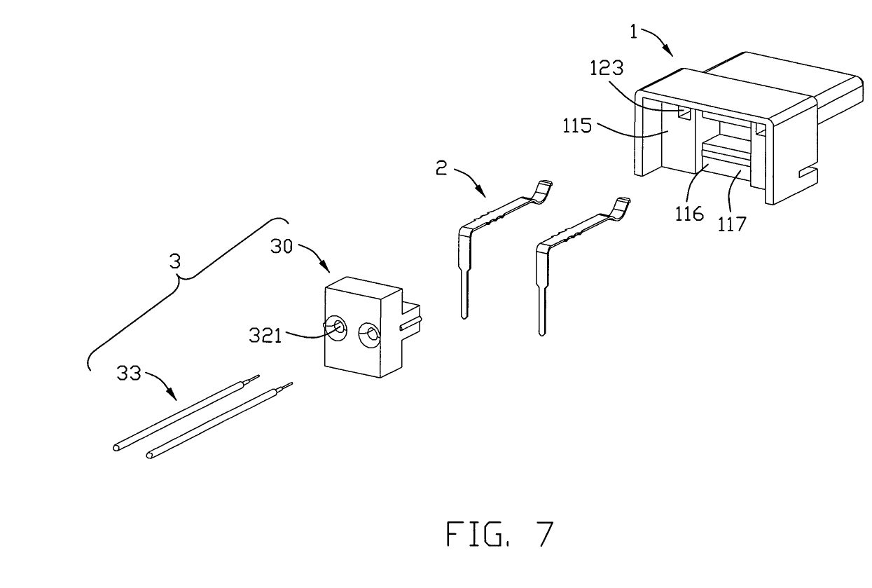

Referring to FIGS. 1-7, an optical receptacle 100 for connecting an optical plug 600 according to the present invention is disclosed. The optical receptacle 100 comprises an insulative housing 1, a pair of power contacts 2 held in the insulative housing 1 for allowing higher voltage to apply more power to the optical connector 100, an optical fiber component 3 retained in the insulative housing 1 for transmitting signals, and a metal shell 4 covering the insulative housing 1.

The insulative housing 1 has a body portion 11 and a tongue portion 12 extending forwardly from the body portion 11. The body portion 11 has a front face 110, a rear face 111 opposite to the front face 110, an upper face 112 and a lower face 113 opposite to the upper face 112. The tongue portion 12 is thinner than the body portion 11 and has an upper surface 121 and a lower surface 122 opposite to the upper surface 121. A geometric profile of the tongue portion 12 is substantially same as that of a standard USB 2.0 A type receptacle (not shown) for allowing the use of existing molds of USB 2.0 receptacle in high volume production. The tongue portion 12 defines a pair of passageways 123 extending through the body portion 11 for positioning the power contacts 2. The passageways 123 are recessed from two sides of the lower surface 122 and extend along a front-to-back direction. The body portion 11 defines a receiving cavity 114 extending inwardly from the front face 110 and extending through the body portion 11, a receiving space 115 extending inwardly from the rear face 111, and a middle room 116 communicating with the receiving cavity 114 and the receiving space 115. The body portion 11 has a stop surface 117 at a front end of the middle room 116.

The receiving cavity 114 is smaller than the middle room 116 in a height direction and a width direction of the insulative housing 1, and the middle room 16 is smaller than the receiving space 115 in the width direction. The receiving cavity 114 is located between the passageways 123, and spaced apart from the passageways 123 in the height direction and the width direction, such that the two passageways 123 and the receiving cavity 114 are arranged at vertices of an imaginary triangle. The body portion 11 defines a retaining slot 118 below the receiving cavity 114 for fixing the metal shell 4. The retaining slot 118 extends along the width direction.

The power contacts 2 are made of copper and are received in the passageways 123 respectively. Each power contacts 2 has a contacting portion 21, a soldering portion 23 and a retaining portion 22 connecting with the contacting portion 21 and the soldering portion 23. The contacting portion 21 extends to the tongue portion 12 and out of the lower surface 122. The soldering portion 23 extends downwardly from the retaining portion 22 and extends beyond the insulative housing 1.

The optical fiber component 3 comprises a lens 30 and a pair of optical fibers 33 retained therein in the embodiment of present invention, wherein the optical fibers 33 are made of glasses. However, in other embodiment, the optical fiber component can just comprises a pair of optical fibers which are made of plastic, and without lens. The lens 30 in the present invention can be made of glass or transparent plastic, and has a base portion 31 and a mating portion 32 extending forwardly from the base portion 31. The mating portion 32 is received in the receiving cavity 114 and exposed to exterior through the front face 10. A front side surface of the mating portion 32 is coplanar with the front face 110 of the body portion 11. The base portion 31 is received in the middle room 116 and abuts against the stop surface 117 for preventing the base portion 31 from moving forwardly. The lens 30 defines a pair of channels 321 extending inwardly from a rear end thereof. The channel 321 does not extend through a front end of the mating portion 32 and forms a convex or concave mirror 34 at a front end thereof. The optical fibers 33 are received in the channels 321 respectively and extend outside the rear face 111.

The optical fibers 33 mate with the lens 34 and extend rearward of the lens 34. The optical fibers 33 are aligned with the mirrors 34 respectively along the front-to-back direction. The optical receptacle 100 defines an offset manner between the mating portion 32 and the tongue portion 12 in the front-to-back direction and the height direction. The optical fibers 33 are located between two power contacts 2 and spaced apart from the power contacts 2 in the height direction and the width direction.

The metal shell 4 comprises a pair of opposed top wall 41 and lower wall 42, a pair of opposed side walls 43 and a rear wall 44 bending downwardly from the top wall 41. A rear side of the lower wall 42 is positioned at the retaining slot 118. The top wall 41 and side walls 43 cover the upper face 112 and side faces of the insulative housing 1 respectively. The optical receptacle 100 defines a room between the metal shell 4 and the tongue portion 12 for receiving the optical plug 600. A geometric profile of the room is substantially same as that of the standard USB 2.0 A type receptacle. The room comprises an upper room 51 between the upper surface 121 of the tongue portion 12 and the top wall 41, and a lower room 52 between the lower surface 122 of the tongue portion 12 and the lower wall 42. The upper room 51 is smaller than the lower room 52. The contacting portions 21 of the power contacts 2 and the front end of the mating portion 32 are exposed to the lower room 52. The top wall 41 and lower wall 42 each has a pair of spring arms 45 extending into the upper room 51 and lower room 52 respectively. Each side wall 43 has a pair of mounting legs 46 extending downwardly for positioning the optical receptacle 100 on a circuit board (not shown).

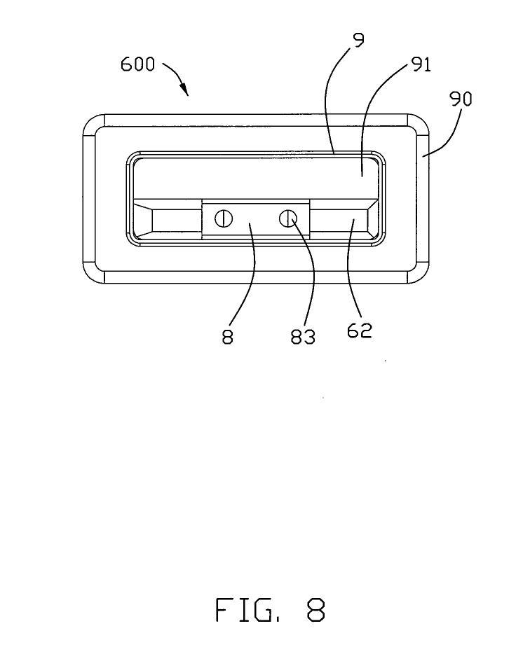

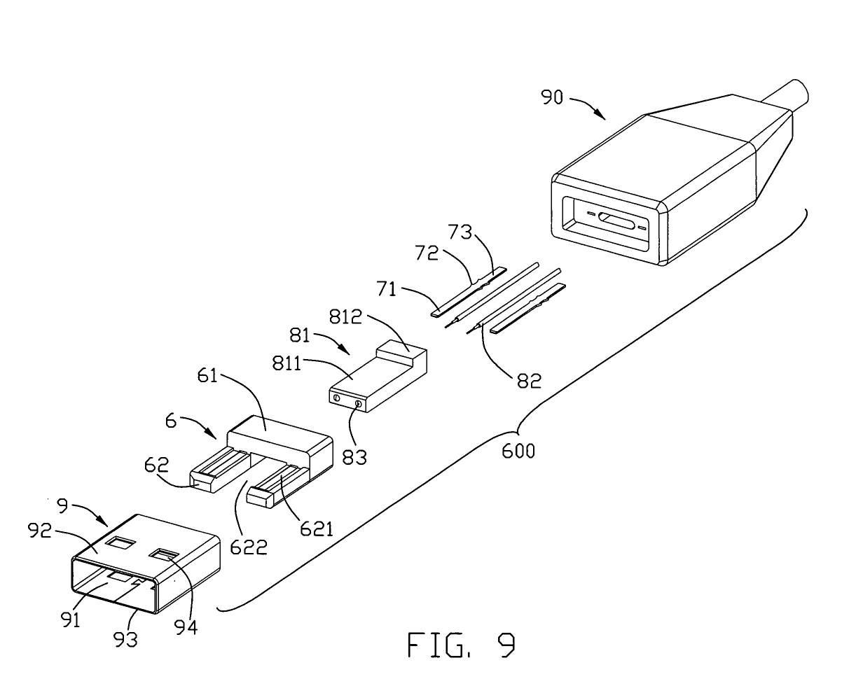

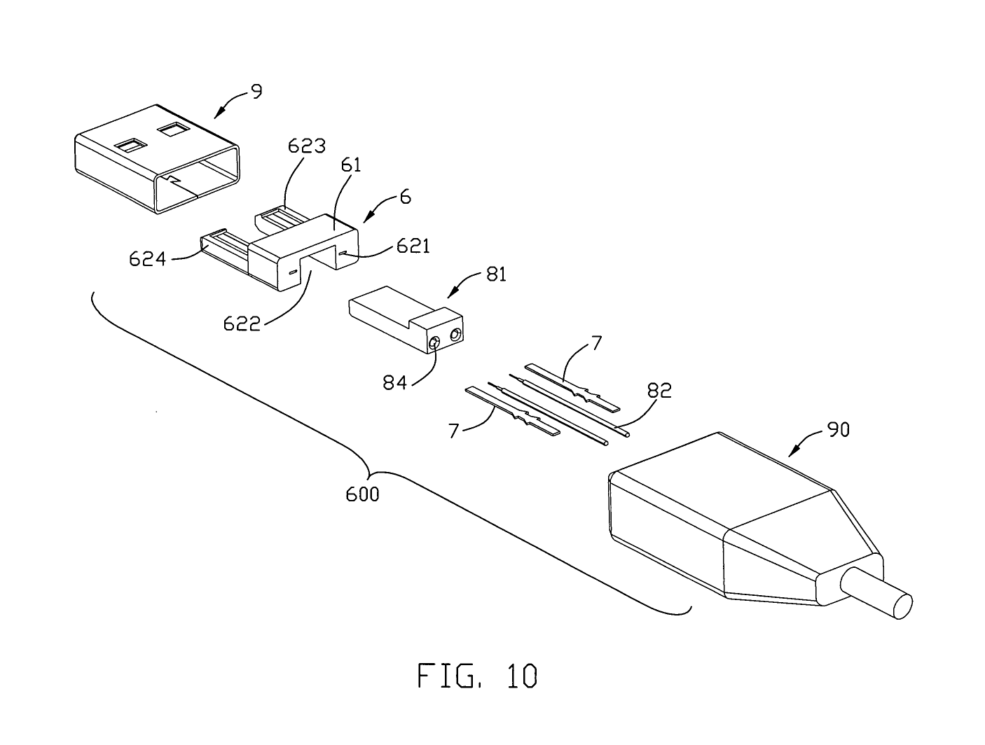

Referring to FIGS. 8-10, the optical plug 600 is adapted to connecting the optical connector 100, and comprises an insulative housing 6, a pair of power terminals 7 for electrically connecting with the power contacts 2 of the optical receptacle 100, an optical fiber component 8 retained in the insulative housing 6 for transmitting signals to the optical fiber component 3 of the optical receptacle 100, a plug metal shell 9 covering the insulative housing 6, and a cable end 90 at a rear side thereof.

The insulative housing 6 has a body portion 61 and a tongue plate 62 extending forwardly from the body portion 61. The tongue plate 62 defines a pair of passageways 621 and a receiving space 622 extending therethrough. The passageways 621 are recessed from an upper surface of the tongue plate 62 and extend through the body portion 61. The receiving space 622 extends through the tongue plate 62 in a height direction of the insulative housing 6, and extends through the insulative housing 6 in a front-to-back direction of the insulative housing 6. The receiving space 622 is located at a middle portion of the tongue plate 62 and divides the tongue plate 62 to a left portion 623 and a right portion 624. The passageways 621 are arranged on the left and right portion 623, 624 respectively.

The power terminals 7 are retained in the passageways 621 respectively. Each power terminal 7 has a contacting portion 71 extending to the tongue plate 62, a retaining portion 72 engaging with the passageway 621, and a tail portion 73 extending into the cable end 90. The contacting portions 71 of two power terminals 7 extend to the left and right portions 623, 624 respectively.

The optical fiber component 8 comprises a lens 81 received in the receiving space 622 and a pair of optical fibers 82 mounted thereon in the embodiment of present invention, wherein the optical fibers 82 are made of glasses. However, in other embodiment, the optical fiber component can just comprises a pair of optical fibers which are made of plastic, and without lens. The lens 81 in the present invention can be made of glass or transparent plastic. The lens 81 defines a pair of channels 84 extending inwardly from a rear end thereof. The channel 84 does not extend through a front end of the lens 81 and forms a convex or concave mirror 83 at a front end thereof. The optical fibers 82 mate with the lens 81 and extend rearward of the lens 81. The optical fibers 82 are aligned with the mirrors 83 respectively along a front-to-rear direction. The optical fibers 82 are partially located between the contacting portions 71 and spaced apart from the contacting portions 71 in the height direction.

The lens 81 has a front portion 811 sandwiched by the left and right portions 623, 624 and a rear portion 812 retained in the body portion 61. A front side surface of the front portion 811 and the front end of the tongue plate 62 are substantially located at a common plane, and an upper surface of the tongue plate 62 and a top face of the front portion 811 are arranged in a common plane too. A geometric profile of an assembly of the tongue plate 62 and the front portion 811 is substantially same as that of a standard USB 2.0 A type plug (not shown) for allowing the use of existing molds of USB 2.0 plug in high volume production. The tongue plate 61 and the front portion 811 are received in the lower room 52 when the optical plug 600 is inserted into the optical receptacle 100.

The plug metal shell 9 surrounds the tongue plate 62 and forms a receiving room 91 between the plug metal shell 9 and the assembly of the tongue plate 62 and the front portion 811. A geometric profile of the receiving room 91 is substantially same as that of the standard USB 2.0 A type plug. The plug metal shell 9 has a pair of opposed upper wall 92 and lower wall 93. The upper wall 92 and lower wall 93 each defines a pair of openings 94 for locking with the spring arms 45 of the optical receptacle 100.

Referring to FIGS. 1-9, the geometric profiles of the optical receptacle and plug 100, 600 are similar to the standard USB 2.0 A type receptacle and plug respectively, thereby the optical receptacle and plug 100, 600 of the present invention are easily to be produced with existing molds of USB 2.0 connector. Furthermore, the optical receptacle and plug 100, 600 of the present invention each has a pair of power contacts 2, 7 which can allow higher voltage to apply more power, and a pair of optical fibers 33, 82 which can transmit signals with a fast transmission speed. In addition, the optical receptacle and plug 100, 600 of the present invention each merely comprises a pair of power contacts 2, 7 and an optical component 3, 8, thereby each of them has a simple structure for being produced easily.

One feature of the invention is to have the electrical transmission lines and the optical transmission lines offset from each other not only in a vertical direction perpendicular to the mating/un-mating direction but also the transverse direction perpendicular to both said vertical direction and said mating/un-mating direction. This offset arrangement may allow completeness/strength of each housing unit 1 or 30 of the connector 100 for holding the corresponding power contacts 2 or the optical fiber components 33, or the housing unit 6, 81 of the connector 600 for holding the corresponding power contacts 7 or the optical fiber component 82.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

1. An optical connector, comprising:
an insulative housing the upper face; and
a signal transmission component disposed in the insulative housing, the signal transmission component consisting of a power transmitter to transmit power signals and an optical fiber component to transmit optical signals.

2. The optical connector as claimed in claim 1, wherein the power transmitter comprises a pair of power contacts.

3. The optical connector as claimed in claim 2, wherein the optical fiber component has a lens retained in the insulative housing and a pair of optical fibers retained in the lens.

4. The optical connector as claimed in claim 3, wherein the lens defines a pair of channels extending inwardly from a rear end thereof, and the optical fibers are received in the channels respectively and extend outside the rear face.

5. The optical connector as claimed in claim 4, wherein the optical fibers is located between the pair of power contacts in a transverse direction of the insulative housing.

6. The optical connector as claimed in claim 5, wherein the power contacts each has a retaining portion retained in the insulative housing, a contacting portion extending forwardly from the retaining portion, the optical fibers are spaced apart from the contact portion in a height direction of the insulative housing.

7. The optical connector as claimed in claim 3, wherein the insulative housing has a body portion and a tongue portion extending forwardly from the body portion, all contact portions of the power contacts and all optical fibers being located at a same side of the tongue portion in the height direction.

8. The optical connector as claimed in claim 7, wherein the body portion defines a pair of opposite front face and rear face and a receiving cavity extending therethrough along a front to back direction of the insulative housing to receive the optical fiber component, and the optical fiber component defines a front side surface which is coplanar with the front face.

9. The optical connector as claimed in claim 4, wherein the tongue portion defines a pair of passageways recessed from two sides of a lower side thereof to receive the contacting portions, the contacting portions are offset from the optical fibers along the front to back direction.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. The optical connector as claimed in claim 7, further comprising a metal shell covering the insulative housing and a room formed between the metal shell and the tongue portion, wherein a geometric profile of the tongue portion and the room are substantially same as that of a standard USB 2.0 A type connector.

22. The optical connector as claimed in claim 6, wherein the insulative housing has a body portion and a tongue plate extending forwardly from the body portion, the tongue plate defining a receiving space extending therethrough along both a front to back direction and a height direction to receive the optical fiber component.

23. The optical connector as claimed in claim 22, wherein the receiving space divides the tongue plate to two parts at two sides thereof, the contacting portions extending to the two parts respectively.

24. The optical connector as claimed in claim 23, wherein a front end surface of the optical fiber component is substantially located at a common plane with a front end of the tongue portion, and a top face of a front side of the optical fiber component and an upper surface of the tongue portion are arranged in a common plane.

25. The optical connector as claimed in claim 22, further comprising a metal shell covering the insulative housing and a receiving room formed between the metal shell and an assembly of the tongue portion and the front side of the optical fiber, wherein a geometric profile of the receiving room and the assembly of the tongue portion and the front side are substantially same as that of a standard USB 2.0 A type connector.

26. An optical connector, comprising:
an insulative housing having a mating port defining a first direction for mating/un-mating, and a second direction extending transversely and perpendicular to said first direction, and a third direction extending vertically and perpendicular to both said first and second directions;
a plurality of electrical contacts disposed in the insulative housing and essentially all located at a first level in the mating port in the third direction; and
an optical fiber component disposed in the insulative housing and having a plurality of optical fibers essentially located at a second level in the mating port in the third direction spaced from the first level so as to assure that electrical transmission and optical transmission are operated at said different first and second levels;
wherein all said electrical contacts and optical fibers are arranged in different positions with each other along the second direction so as to assure no electrical contacts and optical fibers are overlapped with each other in said third direction.

27. The optical connector as claimed in claim 26, wherein said power contacts are located by two sides of said optical fibers in said second direction.

28. The optical connector as claimed in claim 27, wherein all said electrical contacts are held in a first housing unit, and all said optical fibers are held in a second housing unit, said first housing unit and said second housing unit being assembled together to form said insulative housing.
